(19) United States
(12) Patent Application Publication
(10) Pub. No.: US 2016/0215462 A1
(43) Pub. Date: Jul. 28, 2016

(54) Portable Barrier Assembly

(71) Applicant: Timothy Marchetti, Coral Springs, FL (US)

(72) Inventor: Timothy Marchetti, Coral Springs, FL (US)

(21) Appl. No.: 14/603,571

(22) Filed: Jan. 23, 2015

(51) Int. Cl. E01F 13/02; G09F 7/00

(52) U.S. Cl. CPC E01F 13/028; G09F 7/00; E01F 13/022

(57) ABSTRACT

A portable barrier assembly includes a first stanchion and a second stanchion spaced apart from each other on a support surface. A plurality of light emitters is coupled to the first stanchion and the second stanchion. An actuator is coupled to the stanchions and the light emitters. A spool is positioned within the first stanchion. A strip is extendable from the spool such that the strip extends between the first stanchion and the second stanchion. The spool retracts the strip into the pole when the strip is not in use. A curtain is provided. A plurality of couplers is coupled to the curtain. Each of the couplers engages one of the openings such that the curtain extends downwardly from the strip. A plurality of panels each has indicia printed thereon. Selected ones of the panels are removably coupled to the strip, making the indicia visible to the observer.

### BACKGROUND OF THE DISCLOSURE

### Field of the Disclosure

The disclosure relates to barrier devices and more particularly pertains to a new barrier device for concealing an area from an observer.

### SUMMARY OF THE DISCLOSURE

An embodiment of the disclosure meets the needs presented above by generally comprising a first stanchion and a second stanchion spaced apart from each other on a support surface. A plurality of light emitters is coupled to the first stanchion and the second stanchion. The light emitters make the stanchions visible to an observer. An actuator is coupled to the stanchions. The actuator is electrically coupled to the light emitters and the actuator actuates and de-actuates the light emitters. A spool is positioned within the first stanchion. A strip is extendable from the spool such that the strip extends between the first stanchion and the second stanchion. The spool retracts the strip into the pole when the strip is not in use. A curtain has a top edge and a bottom edge and the curtain is comprised of a translucent material. A plurality of couplers is coupled to the curtain and the couplers are positioned proximate the top edge. The couplers is distributed along the curtain. Each of the couplers engages one of the openings such that the curtain extends downwardly from the strip. The hook on each of the bases engages the curtain proximate the bottom edge to prevent an area from being visible to an observer. A plurality of panels each has indicia printed thereon. Selected ones of the panels are removably coupled to the strip and the panels are oriented such that the indicia is visible to the observer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a portable barrier assembly according to an embodiment of the disclosure.

FIG. 2 is a top view of an embodiment of the disclosure.

FIG. 3 is a front view of an embodiment of the disclosure in an extended position.

FIG. 4 is a front view of an embodiment of the disclosure in a lowered position.

FIG. 5 is a perspective in-use view of an embodiment of the disclosure.

FIG. 6 is a bottom view of an embodiment of the disclosure.

FIG. 7 is a cross sectional view taken along line 7-7 of FIG. 5 of an embodiment of the disclosure.

FIG. 8 is a cross sectional view taken along line 8-8 of FIG. 5 of an embodiment of the disclosure.

FIG. 9 is a schematic view of an embodiment of the disclosure.

### DESCRIPTION OF THE PREFERRED EMBODIMENT

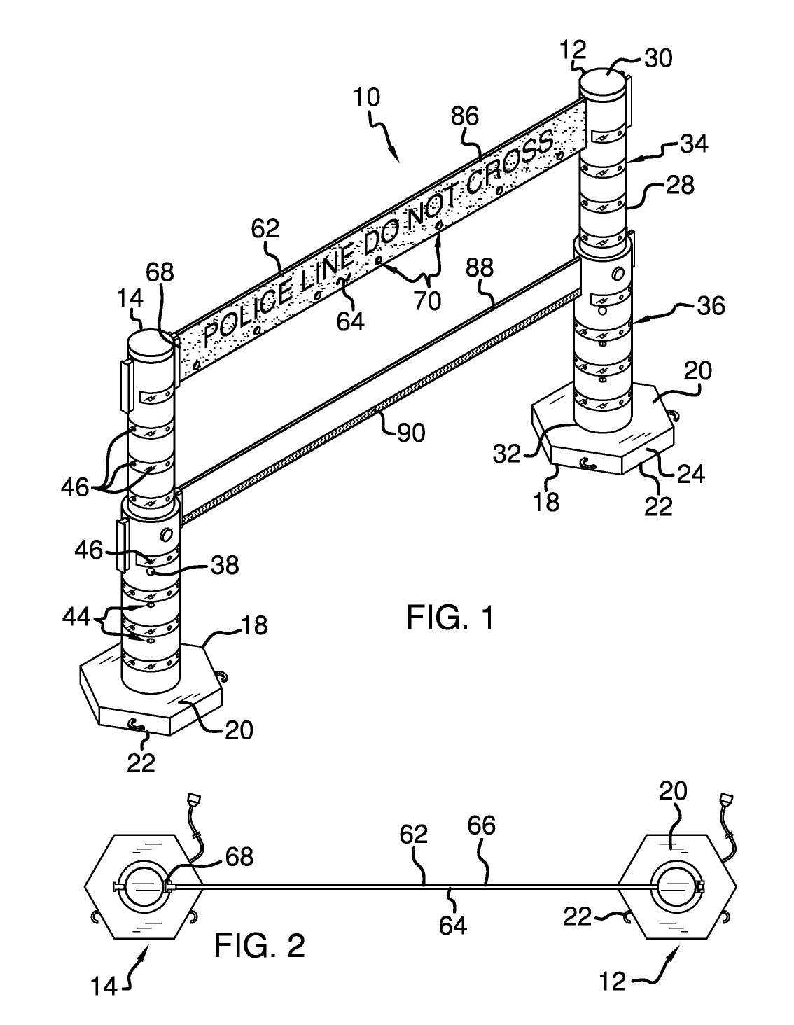

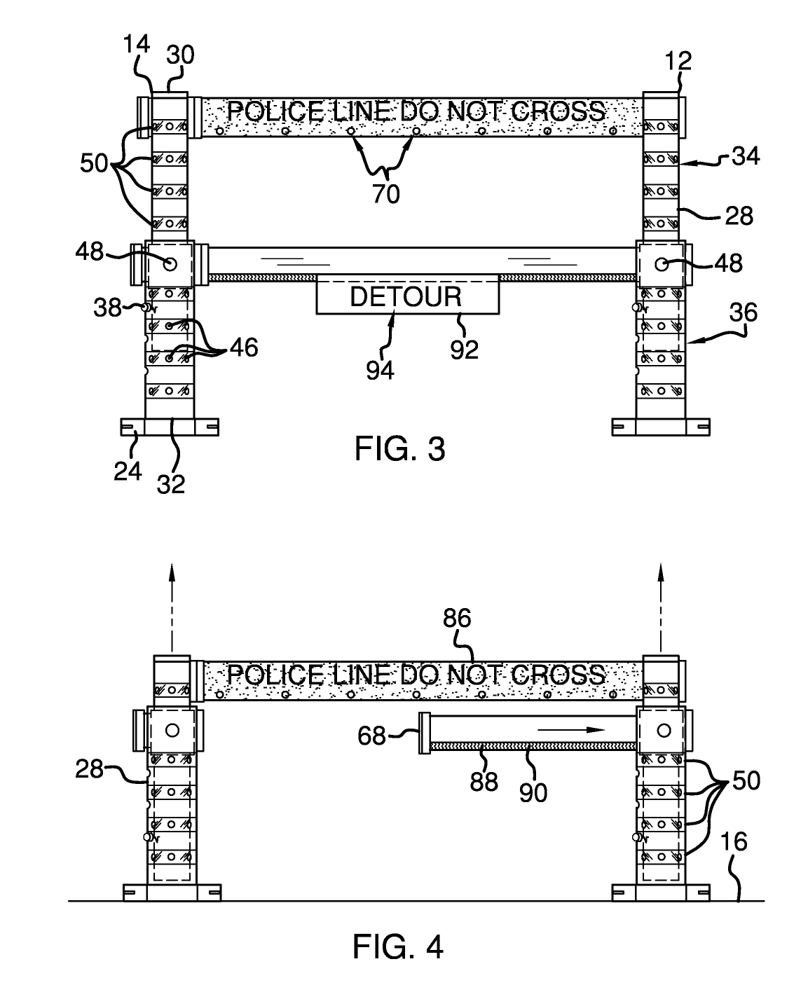

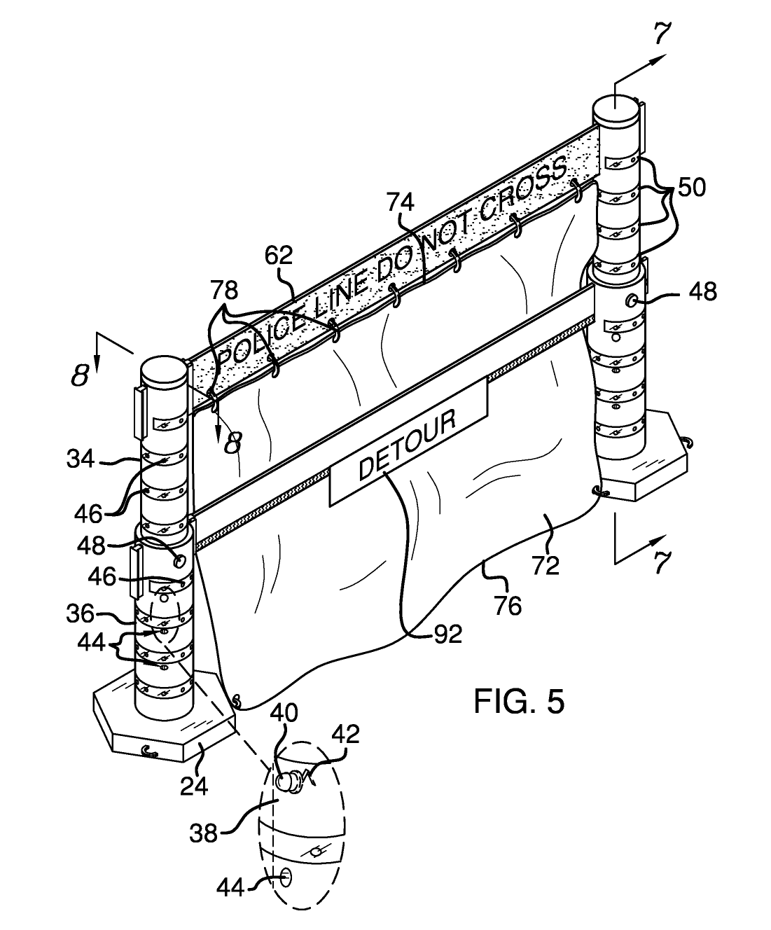

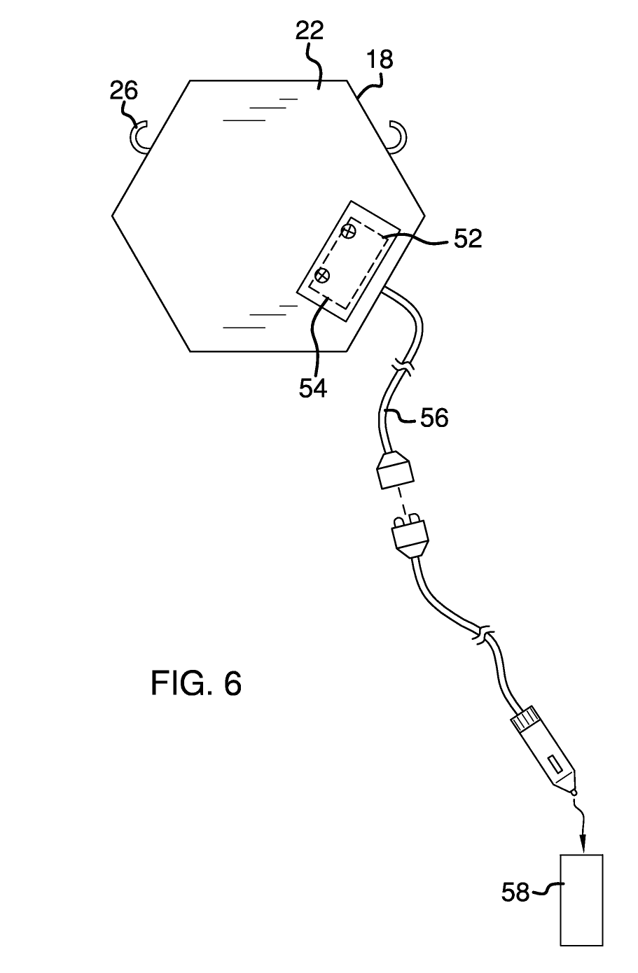

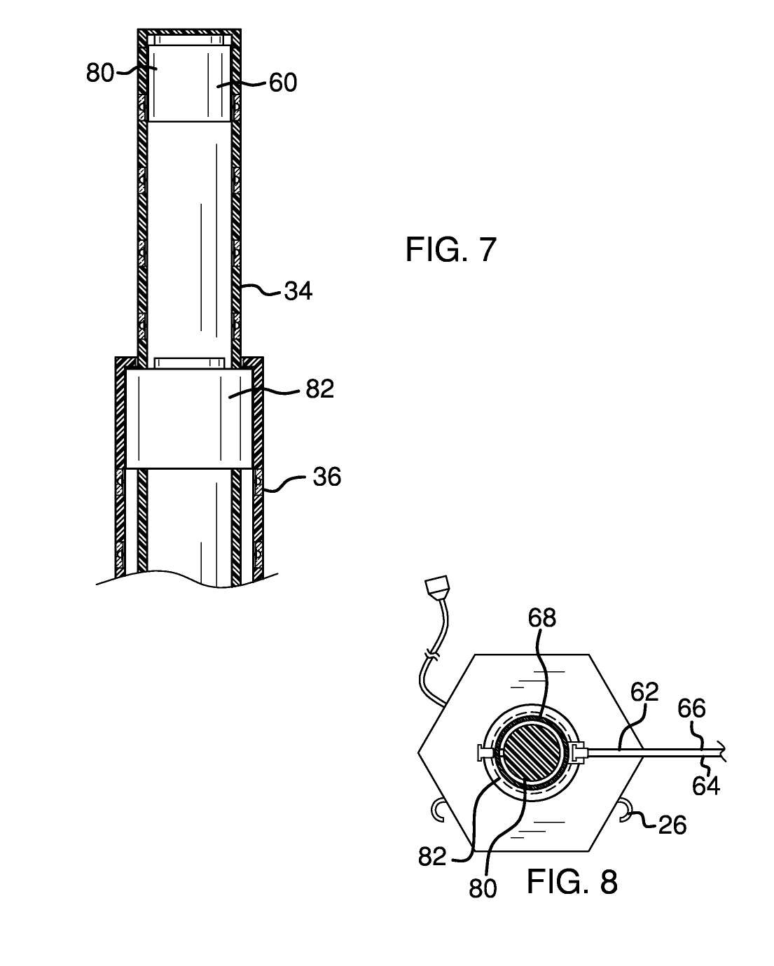

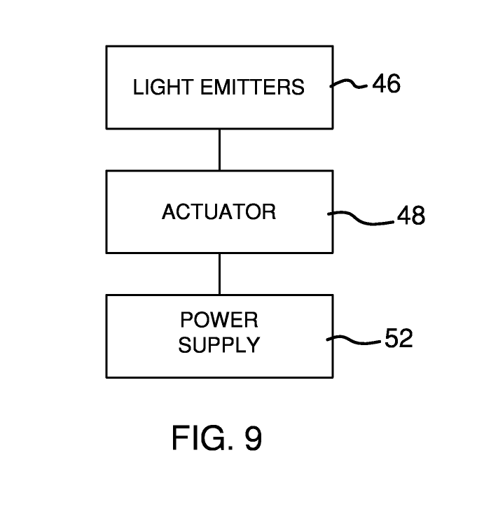

With reference now to the drawings, and in particular to FIGS. 1 through 9 thereof, a new barrier device embodying the principles and concepts of an embodiment of the disclosure and generally designated by the reference numeral 10 will be described.

As best illustrated in FIGS. 1 through 9, the portable barrier assembly 10 generally comprises a first stanchion 12 and a second stanchion 14 each spaced apart from each other on a support surface 16. The support surface 16 may be ground. Each of the first stanchion 12 and the second stanchion 14 comprises a base 18 that has a top side 20, a bottom side 22 and a peripheral edge 24 extending therebetween. The bottom side 22 abuts the support surface 16 and a hook 26 is coupled to the peripheral edge 24.

Each of the first stanchion 12 and the second stanchion 14 further comprise a pole 28 that has a top end 30 and a bottom end 32 and the bottom end 32 is coupled to the top side 20. The pole 28 comprises a top section 34 slidably coupled to a bottom section 36. The pole 28 has a telescopically adjustable height with a maximum height of at least 6 feet.

A lock 38 is coupled to the top section 34 and the lock 38 engages the bottom section 36 to retain the pole 28 at a selected height. The lock 38 may comprise a ball 40 positioned within the top section 34. A spring biasing member 42 biases the ball 40 outwardly from the top section 34. The bottom section 36 has a plurality of openings 44 extending therethrough. The openings 44 extend along an entire length of the bottom section 36. The lock 38 extends outwardly through a selected one of the openings 44.

A plurality of light emitters 46 is coupled to the pole 28 and the light emitters 46 are distributed around the pole 28. The light emitters 46 are distributed between the top end 30 and the bottom end 32 to make the pole 28 visible to an observer. Each of the light emitters 46 may comprise an LED or the like. An actuator 48 is coupled to the pole 28 and the actuator 48 is electrically coupled to the light emitters 46. The actuator 48 actuates and de-actuates the light emitters 46.

Each of the top section 34 and the bottom section 36 may have a plurality of reflective portions 50. The reflective portions 50 are spaced apart from each other and extend along each of the top section 34 and the bottom section 36. The reflective 50 portions may make the pole 28 more visible in dark conditions. The light emitters 46 may be positioned on each of the reflective portions 50.

A power supply 52 is positioned within the base 18 and the power supply 52 is electrically coupled to the actuator 48. The power supply 52 comprises at least one battery 54. Moreover, the power supply 52 includes a cord 56 electrically coupled to and extending outwardly from the power supply 52. The cord 56 is electrically coupled to a power source 58 to charge the power supply 52. The power source 58 may be an electrical outlet or the like.

A spool 60 is positioned within the pole 28 on the first stanchion 12. The spool may 60 be a spring actuated spool or the like. A strip 62 is extendable from the spool 60. The strip 62 has a front surface 64, a rear surface 66 and a distal end 68 with respect to the spool 60. The distal end 68 is removably coupled to the pole 28 on the second stanchion 14 so the strip extends 62 between the first stanchion 12 and the second stanchion 14. The spool 60 retracts the strip 62 into the pole 28 when the strip 62 is not in use.

The strip 62 has a plurality of openings 70 extending through the front surface 64 and the rear surface 66 and the openings 70 are distributed along the strip 62. A curtain 72 is provided that has a top edge 74 and a bottom edge 76. The curtain 72 is comprised of a translucent material. A plurality of couplers 78 is coupled to the curtain 72. The couplers 78 are positioned proximate the top edge 74 and the couplers 78 are distributed along the curtain 72. Each of the couplers 78 engages an associated one of the openings 70 such that the curtain 72 extends downwardly from the strip 62. The couplers 78 may comprise a snap ring or the like. The hook 26 on each of the bases 18 engages the curtain 72 proximate the bottom edge 76 to prevent an area from being visible to an observer.

The spool 60 may be one of a top spool 80 and a bottom spool 82. The top spool 80 is positioned adjacent to the top end 30 of the pole 28. The bottom spool 82 is positioned adjacent to a top end 84 of the bottom section 36. The bottom spool 82 insertably receives the top section 34. The strip 62 may be one of a top strip 86 and a bottom strip 88 each coupled to one of the top spool 80 and the bottom spool 82. A coupler 90 is coupled to the bottom strip 88 and the coupler 90 is coextensive with the bottom strip 88. The coupler 90 may comprise a hook and loop fastener.

A plurality of panels 92 is provided and each of the panels 92 has indicia 94 printed thereon. A selected one of the panels 92 is removably coupled to the coupler 90 on the bottom strip 88. The selected panel 94 may be oriented such that the indicia 94 is visible to the observer. The indicia 94 may comprise words to issue a warning of danger or instructions for the observer.

In use, the first stanchion 12 and the second stanchion 14 are spaced apart adjacent to the area that is to be concealed from the observer. The pole 28 on each of the first stanchion 12 and the second stanchion 14 are set at the selected height. The top strip 86 and the bottom strip 88 are extended outwardly from the first stanchion 12 and the distal end 68 of the top strip 86 and the bottom strip 88 are coupled to the second stanchion 14. The curtain 72 is coupled to the top strip 86 to conceal the area from the observer. The selected panel 92 is coupled to the bottom strip 88. The assembly 10 may be used in by law enforcement, emergency responders or other individuals involved in the response to a vehicle accident or other event that is to be concealed from the observer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable barrier assembly configured to temporarily restrict visibility of and access to an area, said assembly comprising:
a first stanchion and a second stanchion each being configured to be spaced apart from each other on a support surface;
a plurality of light emitters coupled to said first stanchion and said second stanchion, said light emitters being configured to make said stanchions visible to an observer;
an actuator coupled to said stanchions, said actuator being electrically coupled to said light emitters, said actuator actuating and de-actuating said light emitters;
a spool positioned within said first stanchion;
a strip being extendable from said spool such that said strip extends between said first stanchion and said second stanchion, said spool retracting said strip into said pole when said strip is not in use;
a curtain having a top edge and a bottom edge, said curtain being comprised of a translucent material;
a plurality of couplers coupled to said curtain, said couplers being positioned proximate said top edge, said couplers being distributed along said curtain, each of said couplers engaging one of said openings such that said curtain extends downwardly from said strip, said hook on each of said bases engaging said curtain proximate said bottom edge, said curtain being configured to prevent an area from being visible to an observer; and
a plurality of panels each having indicia printed thereon, selected ones of said panels being removably coupled to said strip, said panels being configured to be oriented such that said indicia is visible to the observer.

2. The assembly according to claim 1, wherein each of said first stanchion and said second stanchion comprises a base having a top side, a bottom side and a peripheral edge extending therebetween, said bottom side being configured to abut the support surface.

3. The assembly according to claim 2, wherein said first stanchion and said second stanchion further comprises a pole having a top end and a bottom end, said bottom end being coupled to said top side, said pole comprising a top section slidably coupled to a bottom section, said pole having a telescopically adjustable height, said pole having a maximum height of at least 6 feet.

4. The assembly according to claim 3, further comprising a hook coupled to said peripheral edge, a lock coupled to said top section, said lock engaging said bottom section to retain said pole at a selected height, said light emitters extending between said top end and said bottom end.

5. The assembly according to claim 2, further comprising a power supply positioned within said base, said power supply being electrically coupled to said actuator, said power supply comprising at least one battery, said power supply including a cord electrically coupled to and extending outwardly from said power supply, said cord being electrically couplable to a power source wherein said power supply is charged.

6. The assembly according to claim 3, further comprising said strip having a front surface and a rear surface, said strip having a distal end with respect to said spool, said distal end being removably coupled to said pole on said second stanchion, said strip having a plurality of openings extending through said front surface and said rear surface, said openings extending along said strip.

7. A portable barrier assembly configured to temporarily restrict visibility of and access to an area, said assembly comprising:
a first stanchion and a second stanchion each being configured to be spaced apart from each other on a support surface, each of said first stanchion and said second stanchion comprising:
a base having a top side, a bottom side and a peripheral edge extending therebetween, said bottom side being configured to abut the support surface;
a hook coupled to said peripheral edge;
a pole having a top end and a bottom end, said bottom end being coupled to said top side, said pole comprising a top section slidably coupled to a bottom section, said pole having a telescopically adjustable height, said pole having a maximum height of at least 6 feet;
a lock coupled to said top section, said lock engaging said bottom section to retain said pole at a selected height;
a plurality of light emitters coupled to said pole, said light emitters being distributed around said pole, said light emitters being distributed between said top end and said bottom end, said light emitters being configured to make said poles visible to an observer;
an actuator coupled to said pole, said actuator being electrically coupled to said light emitters, said actuator actuating and de-actuating said light emitters;
a power supply positioned within said base, said power supply being electrically coupled to said actuator, said power supply comprising at least one battery, said power supply including a cord electrically coupled to and extending outwardly from said power supply, said cord being electrically couplable to a power source wherein said power supply is charged;
a spool positioned within said pole on said first stanchion;
a strip being extendable from said spool, said strip having a front surface and a rear surface, said strip having a distal end with respect to said spool, said distal end being removably coupled to said pole on said second stanchion such that said strip extends between said first stanchion and said second stanchion, said spool retracting said strip into said pole when said strip is not in use, said strip having a plurality of openings extending through said front surface and said rear surface, said openings being distributed along said strip;
a curtain having a top edge and a bottom edge, said curtain being comprised of a translucent material;
a plurality of couplers coupled to said curtain, said couplers being positioned proximate said top edge, said couplers being distributed along said curtain, each of said couplers engaging an associated one of said openings such that said curtain extends downwardly from said strip, said hook on each of said bases engaging said curtain proximate said bottom edge, said curtain being configured to prevent an area from being visible to an observer; and
a plurality of panels, said panels having indicia printed thereon, selected ones of said panels being removably coupled to said strip, said panels being configured to be oriented such that said indicia is visible to the observer.
